(19) United States
(12) Patent Application Publication
(10) Pub. No.: US 2006/0082183 A1
(43) Pub. Date: Apr. 20, 2006

(54) Portable foldaway windshield with dual powered air filtered cooling fans for a child stroller or carriage tray

(76) Inventor: Donald Dwain Hudson, Brooklyn, CT (US)

Correspondence Address: Donald D. Hudson, 549 Wauregan Road, Brooklyn, CT, 06234, US

(21) Appl. No.: 10/966,310

(22) Filed: Oct. 14, 2004

(51) Int. Cl. B60J 1/00

(52) U.S. Cl. 296/77.1

(57) ABSTRACT

The present invention relates the child stroller and carriage transportation industry and more specifically to the wind and sun child protection portion of that industry, in which the device of the present invention is installed directly onto stroller or carriage tray the user chooses. The device of the present invention includes a portable foldable formed transparent windshield including two attached hinged side panels on either side of the windshield made of a non-shatter material such as lexon or plexiglass combined a control panel with cooling fans adapted with filters that operates with battery and solar power, to be removably secured to a child stroller or carriage tray with adjustable clamping means, providing stability, and a quick, easy, light weight means for protecting a child within the stroller against outdoor elements while also providing a means of combating heat and humidity with cool filtered air. It also provides easy access to the child. The user simply loosens the holding clamps, unfolds the side panels, place the windshield onto the stroller or carriage tray, slide up the adjustable holding clamps and tighten the knobs to secure it in place and select the power source and fan speed. The adjustable slide clamps also provides quick removal and foldability for storage of the assembly when not in use.

### BACKGROUND OF THE INVENTION

Various sun shields, wind screens and covers for baby strollers or the like have been provided in the past. Many of these are complex flexible structures needed to form an enclosure, with none successful due to time consumption and difficult setup procedures needing a frame structure for setup and stability or attachment means. Creating high cost to manufacture. Although some provide means of protection from outdoor elements, all of them require a frame structure for attachment and are collapsible, none of them are a formed convex shaped transparent shield, which is foldable with built-in cooling, fan or fans with filters to provide cool filtered air protect the child from heat and humidity which can be attached and removed quickly to the stroller or carriage tray. In U.S. Pat. No. 1,339,527 issued to Sperling, a collapsible screen for baby carriages is disclosed which includes a ruffle attached to perimeter of the screen containing a concealed coil spring, which is used for providing shape to the screen. An embodiment adapted for stroller is not disclosed. In U.S. Pat. No. 1,770,841 issued to Clyman, discloses a cover for a baby carriage which includes a mesh top, side and end pieces and stitched edges reinforced with piping in the form of tape. The ability to be collapsed for storage is not disclosed. In U.S. Pat. No. 4,582,355 issued to Hall, discloses a retractable weather guard for a child stroller or baby carriage, which includes a sheet of impervious flexible clear plastic material and a top canopy but does include a frame needed for providing shape, and stability in the wind. In U.S. Pat. No. 6,263,894 issued to LaMantia, discloses an insect netting assembly for a baby stroller as, in U.S. Pat. No. 5,184,865 issued to Mohtasham, discloses a an insect netting assembly for a baby stroller. In the embodiment shown in FIGS. 1 and 2, an assembly in the shape of an arched enclosure, which includes a pair of spring rods, is shown. The assembly is collapsible but requires disassembly of the structure.

### OBJECTS OF THE PRESENT INVENTION

It is an object of the present invention to provide a portable foldaway windshield that is made of shatter proof, resilient transparent material.

It is another object of the present invention to provide a portable foldaway windshield that is resistant to outdoor elements.

It is another object of the present invention to provide a portable foldaway windshield formed to fit directly and perfectly onto a childs stroller or carriage tray.

It is another object of the present invention to provide a foldaway windshield that is portable and foldable for easy storage.

It is another object of the present invention to provide a portable foldaway windshield with built-in cooling fans to combat heat and humidity.

It is another object of the present invention to provide a portable foldaway windshield with control panel with a variable a fan speed switch, and a power selection switch.

It is another object of the present invention to provide a portable foldaway windshield with fans that can be operated by solar and battery power.

It is another object of the present invention to provide a portable foldaway windshield with fans adapted with replaceable air intake filters.

It is another object of the present invention to provide a portable foldaway windshield that is tinted to reduce sun glare and radiation.

It is another object of the present invention to provide a portable foldaway windshield with three adjustable slide clamps for easy attachment and removal from the stroller or carriage tray.

It is another object of the present invention to provide a portable foldaway windshield for a stroller or carriage tray, which, is simple and inexpensive to manufacture.

It is another object of the present invention to provide a portable foldaway windshield that allows easy viewing and access to the child

Accordingly, it is a principal object of the present invention to provide improved elements and arrangements thereof in an apparatus for the purposes describe which is dependable and fully effective in accomplishing its intended purposes.

These and other objects of the present invention will become readily apparent upon further review of the following specifications and drawings.

### SUMMARY OF THE INVENTION

The present invention overcomes all of the undesirable problems that are inherent in the wind and sun protection devices for child strollers of the prior art the present invention allows the user to attach the device with no frame structure for setup, stability or flexible material needed to form an enclosure. In addition to its novel structure, the present invention combines cooling fans comprised with filters that can be operated by both battery and solar power, which allows the user to choose a power source according to the outside conditions to save on battery use to operate the device. The device of the present invention consist of two hinged shield panel members, and main front shield which are formed of a shatter proof material and formed to fit directly onto the tray of a stroller or carriage attached firmly with three adjustable slide clamping means with one attached to the main windshield and one attached to each of the side shield panel members. The main shield is also outfitted with a control panel, which, consist of a power selection switch to choose the source of power to run the fans along with a variable fan speed switch to control the volume of air circulation entering into stroller or carriage cab onto the child. The user simply has to unfold the side panels of the present invention and place it onto the stroller or carriage tray slide each of the adjustable holding clamps up in position and tighten each knob, to secure in place. Select the power source and choose the desired fan speed or loosen for quick removal and fold together for easy storage when not in use. This makes this invention convenient and economical to make, sell, and use.

### BRIEF DESCRIPTION OF DRAWINGS

FIG. 1, is a front view of a child stroller or carriage having the portable foldaway windshield with air filtered cooling fans of the present invention.

FIG. 2, is a side view of a child stroller or carriage having the portable foldaway windshield with air filtered cooling fans of the present invention.

FIG. 3, is a front view of embodiment of the portable foldaway windshield with air filtered cooling fans of the present invention.

FIG. 4, is a side view of the embodiment of the portable foldaway windshield with air filtered cooling fans of the present invention.

FIG. 5, is a front view of the adjustable clamping means of the portable foldaway windshield with air filtered cooling fans to a child stroller or carriage tray.

FIG. 6, is a side cross sectional view of the adjustable clamping means of the foldaway windshield with air filtered cooling fans to a child stroller or carriage tray.

FIG. 7, is a side cross sectional view of the cooling fan with the air filter element attachment of the present invention.

FIG. 8, is a front view of the power and fan control panel of the present invention.

FIG. 9, is a back view of the portable foldaway windshield with air filtered cooling fans of the present invention in the fold and storage position.

### DETAILED DESCRIPTION OF DRAWINGS

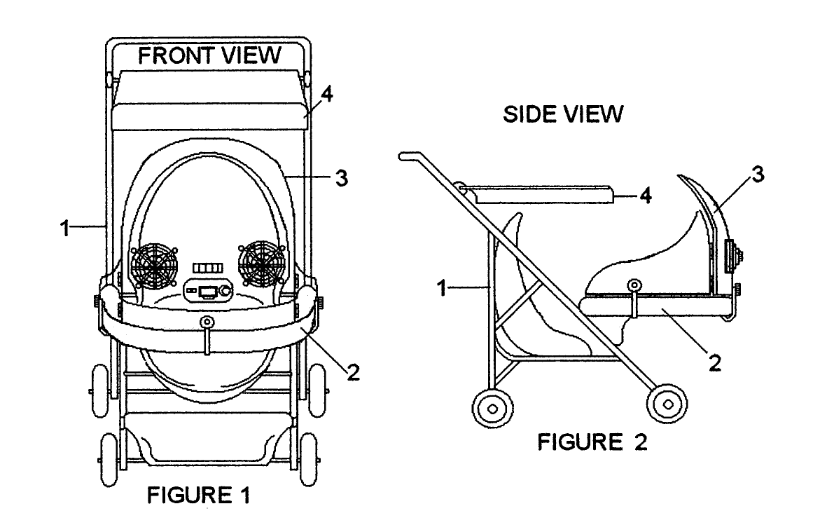

Referring to the drawings and more particularly to FIG. 1, there is generally at 3, the portable foldaway windshield with built-in air filtered cooling fans is shown secured to a stroller tray at 2, of child stroller at 1, with a stroller overhead cover at 4, shown from a front view.

As in FIG. 1, the drawing of FIG.2, is the same description as but, shown from a side view.

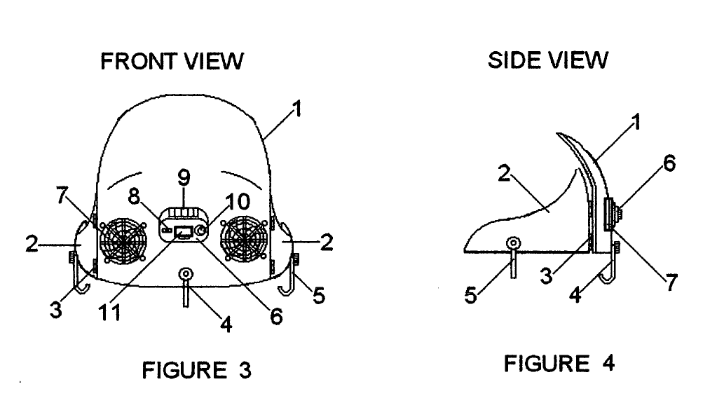

Referring to FIG. 3, shown from the front view and FIG. 4, shown from the side view with the exception of 8, 9, 10 and 11 not shown in FIG. 4, is the embodiments of the present invention whereas 1, being the main wind deflector shield with 2, being the formed side panel members attached to wind deflector shield 1, and made foldable for easy storage when not in use by hinges 3. The main windshield and side panel members are made of a tinted but, transparent resilient material such as lexon or plexiglass to control sun glare while still providing viewing ability for and of the child inside the stroller. The main wind deflector shield 1, has two permanently built-in cooling fans 7, with replaceable air intake filters to extract outdoor or indoor air borne elements from entering into the stroller cab while still providing cool clean air to combat heat and humidity on the child. The cooling fans 7, are operated from the control panel 6, which consist of power selector switch 8, which is a three position switch to select power source to operate the fans or off if not needed. A fan speed selection switch 10, which has low, medium, and high positions and the cooling fans 7, can be powered by either a battery located in the battery compartment 11, on hot and humid nights or solar power supplied by a solar panels 9, which can be used on sunny days to save battery power. The present invention is quickly removed and firm and securely attached to a child stroller tray, with no frame structure to setup and no Velcro, laces or zippers other than the stroller tray, with adjustable slide clamps at three points as shown in FIG. 1, with the main windshield slide adjustable clamp 4, and also two side panel adjustable clamps 5, shown in FIG. 3

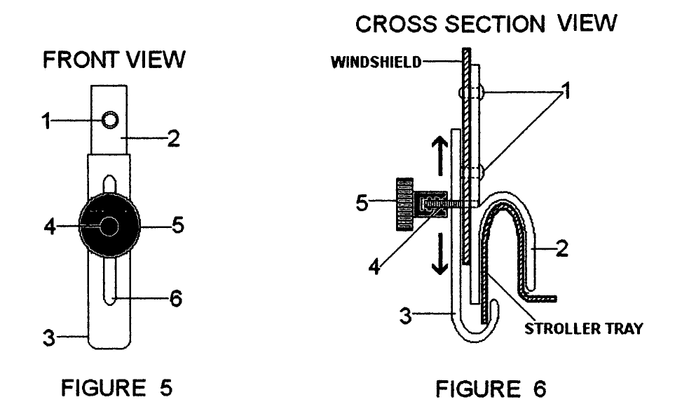

Referring now to FIG. 5, the front view and FIG. 6, the cross section side view of the adjustable slide clamping means of the present invention to attach to a stroller tray as shown in FIG. 1 and FIG. 2, the inside windshield clamp rivets 1, which attaches the windshield to the inside upper tray holding clamp 2, which provides structure setup and upper stability for the present invention and along with the outside lower tray slide clamp 3, which has a slot 6, in FIG. 5 and slides on a threaded stud 4, which is a part of the inside upper tray holding clamp 2, which hooks to underside of the stroller tray lip by loosening the adjustment knob 5, and adjusts the lower slide clamp up and down to attach the present invention firmly to the stroller tray. This eliminates the need of a frame structure or overhead top cover for setup and secure means of laces, zippers or velcro of the shielding material.

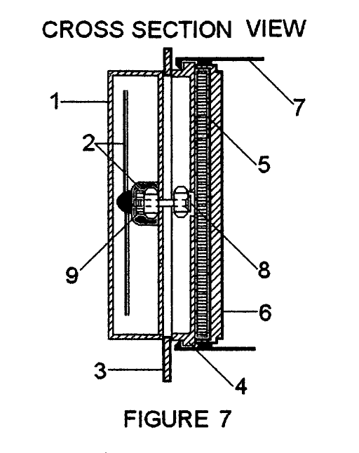

Referring now to FIG. 7, is a cross section side view of the cooling fans with replaceable air intake filters assembly of the present invention with the front fan cover and fan housing at 1, containing the fan and motor 2, which is mated to the windshield 3,through a hole cut in the windshield 3, to fit the back of fan housing 1, to the back fan cover 4, with fastening screws 8, and fastening nuts 9, to hold it securely to windshield. The fan back cover have tab slots seen at 4, which serves to hold the replaceable air filter 5, in place with the air filter cover 6, which is easily removed by squeeze type release tabs 7, for simplicity of changing the filter.

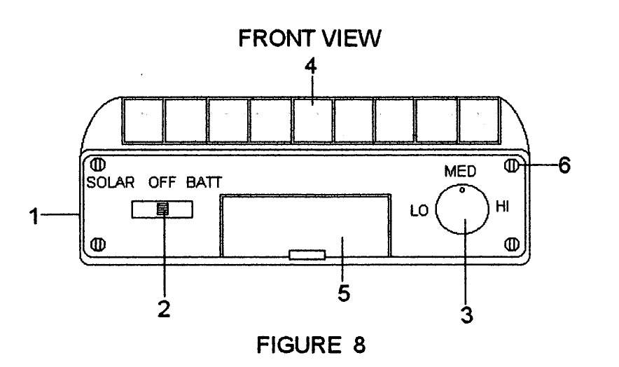

In FIG. 8, the power and control panel 1, consist of a power selection switch 2, which offers the user the choice to use either battery power located in the battery compartment 5, or solar power supplied by the solar panels 4, which helps in saving battery power during the day and the use of battery in the night times or off when not in use. The power for running the fans are distributed through a fan speed switch 3, which offer the user the choice of low, medium, and high speed settings to control the volume of air flow onto the child inside the stroller. The control panel 1, is attached to the front of the windshield with four screws 6, and as shown in FIGS. 3 and 4.

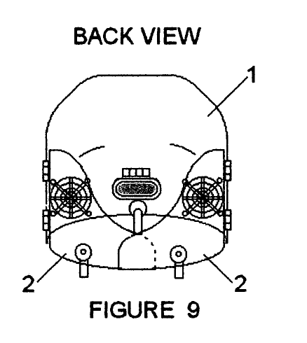

In FIG. 9, is a back view embodiment of the present invention with the main front shield 1, and the attached hinged side panel members 2, also shown in FIG. 3 in the folded position for storage.

Although preferred embodiments of the present invention have been illustrated, it will be understood that modification may be made within the spirit and scope of the appended claims.

What I claim as my invention is:

1. A portable foldaway windshield with dual powered air filtered cooling fan or fans to be used in combination with a child stroller or carriage outfitted with a tray, said foldaway molded windshield comprising:
a convex shaped front shield molded of a resilient shatter proof transparent tinted material outfitted with cooling fan or fans with filters and a control panel attached to the front side in which to operate the fan speed and fans on a dual power system and having a adjustable slide clamp for secure means to front of a stroller or carriage tray for means of supporting the assembly;
a left side curved elongated panel member made of a resilient shatter proof transparent tinted material having a adjustable slide clamp for secure means to the left side of the stroller or carriage tray for means of supporting the assembly and is attached to the front shield with a hinge that foldable together;
a right side curved elongated panel member made of a resilient shatter proof transparent tinted material having a adjustable slide clamp for secure means to the right side of the stroller or carriage tray for means of supporting the assembly and is attached to the front shield with a hinge that foldable together;

2. A portable foldaway windshield with dual powered air filtered cooling fan or fans as defined in claim 1, wherein the front shield, left and right side panel members is releasably secured through the use of adjustable slide clamps with adjustment knobs.

3. A portable foldaway windshield with dual powered air filtered cooling fan or fans as defined in claim 1, the adjustable slide clamps are permanently attached to the front shield, left and right side panel members.

4. A portable foldaway windshield with dual powered air filtered cooling fan or fans as defined in claim 1, wherein the front shield, left and right side panel members are formed out of a shatter proof tinted transparent lexon material.

5. A portable foldaway windshield with dual powered air filtered cooling fan or fans as defined in claim 1, wherein the front shield, left and right side panel members are formed out of a shatter proof tinted transparent plexiglass material.

6. A portable foldaway windshield with dual powered air filtered cooling fan or fans as defined in claim 1, wherein the fan or fans are permanently attached directly to the front shield.

7. A portable foldaway windshield with dual powered air filtered cooling fan or fans as defined in claim 1, wherein the fan or fans are adapted with air filter elements which are easily replaceable.

8. A portable foldaway windshield with dual powered air filtered cooling fan or fans as defined in claim 1, wherein the control panel is permanently attached to the front shield.

9. A portable foldaway windshield with dual powered air filtered cooling fan or fans as defined in claim 1, wherein the control panel is comprised of a battery compartment and a solar panel connected to a power selector switch in order to operate the fan or fans with dual power.

10. A portable foldaway windshield with dual powered air filtered cooling fan or fans as defined in claim 1, wherein the control panel having a variable speed selector switch to control the volume of air circulating from the fan or fans.

11. A portable foldaway windshield with dual powered air filtered cooling fan or fans as defined in claim 1, wherein the elongated left and right side panels are attached to front shield with hinges and are foldable together.
